(19) United States
(12) Patent Application Publication
(10) Pub. No.: US 2009/0158610 A1
(43) Pub. Date: Jun. 25, 2009

(54) Thermal coal upgrading processor

(76) Inventors: Harry E. Bonner, Sheridan, WY (US); Roger B. Malmquist, Butte, MT (US); Ray W. Sheldon, Huntley, MT (US)

Correspondence Address: ANTOINETTE M. TEASE, P. O. BOX 51016, BILLINGS, MT, 59105, US

(21) Appl. No.: 11/652,180

(22) Filed: Jan. 11, 2007

Related U.S. Application Data
(60) Provisional application No. 60/759,514, filed on Jan. 17, 2006.

(51) Int. Cl. C10L 9/08; F26B 17/14

(52) U.S. Cl. 34/171; 34/165; 34/234; 44/626

(57) ABSTRACT

An apparatus for heating low rank coal having a processor with transverse baffles. Coal is introduced into the top of the processor and passes through the processor by gravity. Heated relatively inert gas is introduced into the processor and flows through the coal, heating the coal and removing moisture from the coal. The temperature of the heated process gas, the size of the coal, the size of the inlet and outlet openings of the processor and the rate of flow of the coal are selected for optimum efficiency.

### CROSS REFERENCE TO RELATED APPLICATION

The present application is related to provisional patent application Ser. No. 60/159,314 filed Jan. 17, 2006.

### BACKGROUND OF THE INVENTION

1. Field of the Invention

The subject invention modifies a commercial grain dryer to economically apply it as a thermal processor for upgrading coal and similar materials (herein referred to as coal).

2. Description of Related Art

Due to the inventors' extensive history with and knowledge of the SynCoal® process this invention is compared to the original SynCoal Process for explanatory purposes. (SynCoal® is a registered trademark for both the process and the product that results from the process although the ® is not generally included herein for brevity.) The original SynCoal process was patented by Monroe Greene, U.S. Pat. No. 4,725,337 issued Feb. 16, 1988 and U.S. Pat. No. 4,810,258 issued May 7, 1989.

The demonstration SynCoal facility operated throughout the 1990s. The gas to solids contacting components selected for the original SynCoal facility for treating the coal were vibrating, fluidized bed (VFB) processors (aka conveyor dryers) requiring relatively high differential pressure process gas fans. While the VFBs provide an effective mechanism for contacting the coal with the process gas, they proved to be difficult to maintain due to excessive thermal and mechanical stresses and resulted in removal of significant quantities of fine material from the coal and consumed large amounts of electric power for the high pressure process gas fans. Additionally, subsequent efforts to develop larger facilities found it was nearly impossible to expand the productive capacity of the individual VFB processor units.

Aeroglide Corporation commercially manufactures a tower grain dryer which provides a long residence time for the grain while gently mixing the grain and directly contacting the grain with distributed low velocity heated air in a cross current manner. This dryer is uniformly baffled with fixed horizontal inverted V plates that are used to distribute the heated inlet air throughout the tower dryer alternated with inverted V plates oriented perpendicular to the inlet inverted V plates that allow the moist air to exit. The arrangement of these baffles “mix” the grain (without the use of moving parts) as the grain descends through the tower dryer. At the bottom of the dryer is a discharge device that removes the grain uniformly from the entire tower cross-section to maintain a “plug flow” resulting in consistent contact time with the heated air.

The present invention converts this basic design into a thermal processor capable of higher energy exchange and larger economic capacity by modifying the tower cross-section dimensions and/or inlet and outlet baffle dimensions to accommodate flow rates commensurate with the anticipated gas flow rates expected when thermally upgrading coal. The SynCoal upgrading process requires the use of relatively inert moderate temperature process gas to heat the coal and lower exit gas velocities to minimize removal of fine particles from the solids being treated.

The inventors are aware of the following:

| | | |
|---|---|---|
| 1,568,738 | Jones | Jan. 05, 1926 |
| 1,623,553 | Randolph | Apr. 05, 1927 |
| 2,187,799 | Baughman | Jan. 23, 1940 |
| 3,031,773 | Dunkle | May 01, 1962 |
| 3,800,508 | Zenz | Apr. 02, 1974 |
| 4,725,337 | Greene | Feb. 16, 1988 |
| 4,810,258 | Greene | May 07, 1989 |

Jones '738 teaches an apparatus where dryer gas is introduced to a vertical column of coal contained by a screen, exiting the opposite side of the column but does not provide for mixing of the solids. This apparatus cannot be scaled up to large commercial applications and maintain a reasonably low pressure drop/short gas path through the coal being processed.

Randolph '553 teaches baffling concept with parallel gables for inlet and outlet gas purposes. Drying gas flows into one side of the drying chamber, flows out the bottom of a gable, through a portion of the coal and into an exit gable that discharges to the opposite side of the drying chamber. The patent discussed warm air as the drying medium. Randolph does not teach bi-directional mixing (E-W, N-S) or optimization of gas flow.

Baughman '799 teaches a zig zag mixing cross flow dryer with coal cascading downward through the drying chamber bouncing back and forth from one side plate to the other side plate as it falls. The patent does not teach internal solids mixing or gas distribution or identify the source or composition of the drying medium. The apparatus cannot be scaled up to large commercial applications and maintain a reasonably low pressure drop/short gas path through the coal being processed.

Dunkle '773 teaches an apparatus for drying coal using indirect contact for heat transfer, a method for delivering the coal to the dryer, and a means of discharging the product. Indirect heat transfer is a distinct departure from the original SynCoal process as taught by Greene '337 and '258. Dunkle does not teach internal collection of vaporized moisture nor internal mixing of the coal being processed.

Zenz '508 teaches an apparatus for contacting a granular material with a fluid in a vertically oriented vessel that allow the fluid to pass through the granular material treating either the fluid or the material or removal of particulate from the fluid. The lack of mixing, internal gas distribution and different process goals (particulate capture from a gas stream versus thermal processing) are significant differences from the present invention.

### BRIEF SUMMARY OF THE INVENTION

It is an object of the present invention to provide a commercial scale apparatus which provides relatively slow uniform heating by contact between solid particles and low velocity moderately high temperature process gas while gently mixing the solids without large pressure differentials between the processor gas inlets and outlets.

It is a further object of the present invention to provide an apparatus which removes moisture from coal efficiently and economically without removing a significant amount of the volatile organic compounds (VOCs).

In accordance with the teachings of the present invention, there is disclosed an apparatus for heating moisture containing solid granular materials such as low-rank coal, comprising a tower means for passing the coal via gravity from the top of the tower, and baffle means within the tower for passing heated gas through inlet and outlet openings in the tower, thereby reducing the moisture content of the coal.

In further accordance with the teachings of the present invention, there is disclosed a thermal processor for coal to safely and efficiently reduce the moisture content of the coal. A processor has a plurality of baffles, the baffles being disposed transversely in the processor and spaced to accommodate coal flow. Each baffle has a respective end having a cross-sectional area. The ends of the baffles communicate with an inlet plenum or an outlet plenum as required. A source of inert gas is heated to a preselected temperature. The gas is introduced into the inlet plenum wherein the gas is uniformly distributed throughout the coal volume, the gas flows into the processor through the coal and exits to the outlet plenum. An opening is formed in the top of the vertical processor. Untreated coal having a maximum selected size and screened to remove a portion of the fine particles is introduced continuously into the opening in the top of the processor. The coal passes through the processor by gravity. The coal is heated by the heated inert gas to reduce the moisture content but the process does not remove volatile organic compounds.

These and other objects of the present invention will become apparent from a reading of the following specification taken in conjunction with the enclosed drawings.

### BRIEF DESCRIPTION OF THE DRAWINGS

FIG. 1 is a perspective view of the processor of the present invention.

FIG. 2 is a perspective view of the baffles of the present invention with each plane of baffles being perpendicularly aligned with respect to the plane of baffles above and below.

FIG. 3 is an end view of the inlet baffles.

FIG. 4 is an end view of the outlet baffles.

### DESCRIPTION OF THE PREFERRED EMBODIMENTS

The grain dryer of the prior art has been modified for use in the treatment of coal. A plurality of spaced apart inverted V-shaped baffles, spaced according to the flow characteristics of the coal, are disposed transversely in a processor. The overall processor configuration necessarily includes inlet gas distribution and outlet gas collection plenum(s). In the modified design, the moderately high temperature, relatively inert process gas enters the distribution plenum(s). The inlet distribution plenums extend the full height of the operating section of the processor. The depth of the inlet plenum(s) varies from deepest at the supply duct to narrowest at the furthest inlet distribution points to assure uniform flow. The outlet collection plenum(s) are oriented perpendicular to the inlet plenum(s) and extend the full height of the operating section of the processor. The outlet collection plenum(s) may have two exhaust ducts attached to allow the exhaust gas from the upper and lower processor segments to be segregated and sent to different locations. The upper processor exhaust gas will not contain (VOCs) therefore this exhaust gas can be sent directly to a vent system which could involve a particulate collection system. The lower processor exhaust gas could potentially contain limited quantities of VOCs therefore this exhaust gas may need to be further treated or incinerated prior to release.

Due to the large temperature drop of this process gas, the exit gas volume is substantially less than the inlet gas volume. By matching the gas flow openings and baffle sizing to better match the actual flow rates the effective productive capacity can be maximized. The size (and therefore flow capacity) of the baffles is selected such that the flow velocities of the inlet and outlet gases are properly matched to achieve the desired energy input while controlling the outlet velocity to minimize particulate carry over, allowing the inlet gas flow rate to be optimized. The sectional area and velocity of gas into and exiting the baffle determines the volumetric flow rate of gas into and exiting the processor. Baffle sizing can be varied for each section of the processor. The cross-sectional area of the ends of the baffles communicating with the inlet plenum may be larger than the cross-sectional area of the baffles communicating with the outlet plenum.

Untreated coal is screened to provide coal not exceeding design criteria and to remove a portion of the fines. This coal is introduced into an opening in the top of the processor and passes through the processor by gravity feed. The coal is introduced into the opening in the top in a continuous manner so that the removal of moisture from the coal is a continuous, and not a batch, process. There are no moving parts in the processor.

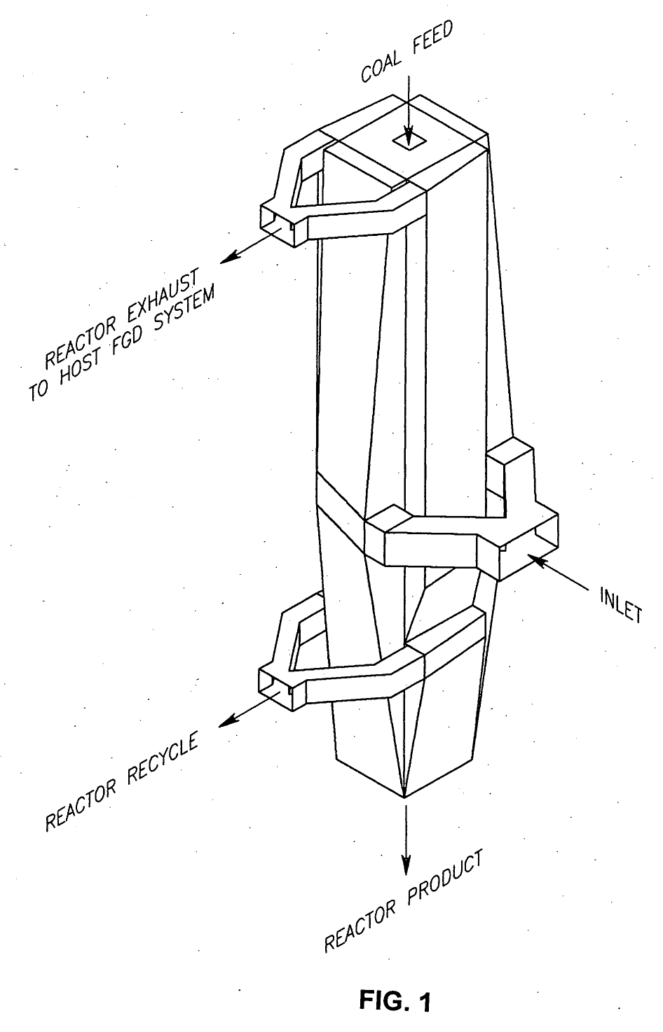

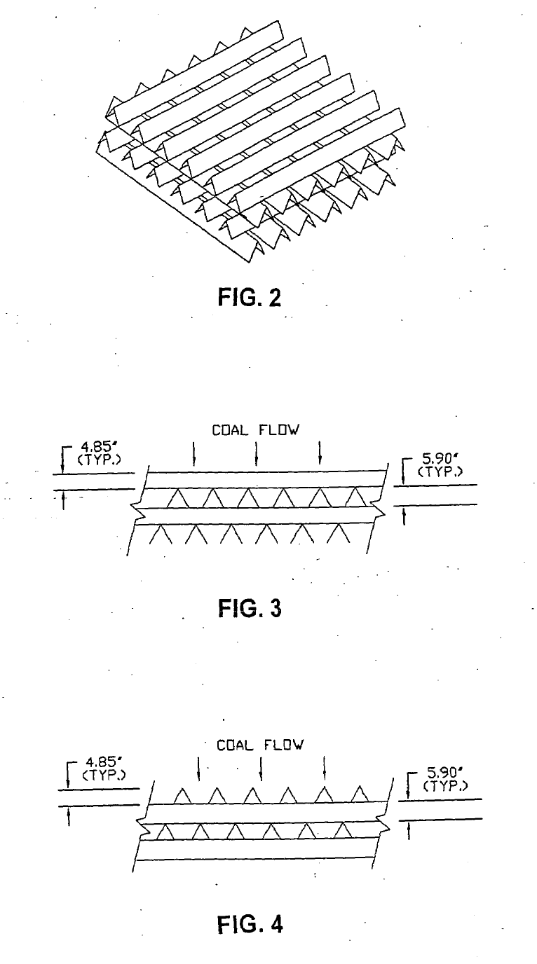

An improved tower processor with no integral moving parts is used to provide an effective and efficient means of contact between the coal and the process gas. Preferably, the processor has a square or rectangular cross-section (FIG. 1). The coal flows by gravity down though the tower processor which is crossed with alternating levels of inverted V inlet and outlet baffles extending the full width of the tower (FIGS. 2-4). Baffles must be configured to promote mass flow of the solids through the processor while moving the solids back and forth to and fro as it descends through the processor. Each baffle has an apex angle of approximately 50°-60°, the angle being determined by the material flow characteristics of the coal. The coal size is a maximum of 3 inches, preferably being 2 inches. A series of baffles are arranged adjacent to one another on any particular plane with a minimum spacing between the individual baffles of approximately 2½-3 times the size of the largest coal particles introduced into the top of the processor. For example, if the coal has a maximum size of 2 inches, the spacing between the baffles would be between 5 and 6 inches. It is preferred that the coal does not exceed two (2) inches. This spacing permits the coal to pass freely through the processor by gravity. The perpendicularly alternated levels of inlet and outlet baffles are configured to gently mix the coal as it descends through the processor while providing uniform process gas distribution and efficient contact with the coal without the high pressure drop required in other processor systems space the process gas only passes through a relatively shallow layer of coal between the inlet and outlet baffles. The baffles on adjacent levels are disposed at approximately 90° with respect to the baffles on the level immediately above or below. This imparts a mixing action and allows the process gas to be directed to the coal flow for the entire height of the processor. As the coal dries and descends through the processor, coal particles will break up by thermal forces and attrition shifting the size distribution of the coal to a smaller average particle size.

The inlet (outlet) flow capacity of a baffle is determined by:
the allowable process gas inlet (outlet) velocity,
the apex angle of a baffle,
the height of a baffle.
   Typically the inlet velocity of the gas from the inlet opening is approximately 60 fps and the outlet velocity from the outlet opening is approximately 40 fps.

The productive capacity of the processor is determined by:
the inlet (outlet) flow capacity of a baffle,
the number of baffles per row,
the number of rows per segment,
the number of segments in the processor.

The outlet plenum is sloped towards slots or exits near the bottom of the processor to allow fine particles that disengage from the outlet gas to rejoin the processed solids at the outlet of the processor without becoming a potential safety concern.

Based upon Stokes Law, if the disengaging velocity of the process gas exiting the coal is approximately 1.4 fps, the maximum entrained particle size is 150 mesh.

Coal is treated using a moderately high temperature, relatively inert process gas in intimate contact with the coal. Although a wide range of temperatures and gas compositions can be applied, ideally inlet gas temperatures would be attemperated and limited to approximately 700° F. to minimize devolatilizing the coal, with the oxygen content as low as possible preferably less than 5% by volume. As the coal is heated and the moisture reduced, the exit gas may be less than 225° F. The mass flow rate of the process gas would be increased by the moisture evaporated, but has a lesser effect than the volume reduction due to the decrease in temperature. In the idealized process example, the decrease in volumetric flow rate related to the decrease in temperature is about 33% while the increase in volumetric flow rate related to the increase in mass is about 8%. By sizing the outlet baffle so the exit velocity does not exceed 40 fps, larger particles will not be carried out with the process exhaust. This also allows the internal gas to solid contact volume and thus the productive capacity to be optimized.

Each processor section may be configured with differing size baffles in order to best match the gas conditions at each stage. Additionally, the inlet and outlet gas streams may be sectionalized with the processor sections to provide process gases of different temperatures or compositions and separate outlet gases for different distribution; i.e., the hottest section off gas being sent to incineration to eliminate any VOC emissions and the cooler off gas from the upper processor sections being directed to a non-incineration emission control device.

The controlling factor for coal processing capacity is related to the ability to introduce heat energy into the system. While the tower processor can be made taller to increase capacity, the construction costs are non-linear and economics limit the total height of the processor. By adjusting the tower cross-section width to depth ratio and/or the inlet and outlet baffles dimensions to reflect desired volumetric flow rates and velocities, the capacity of this processor design can be increased by about 20% while minimizing the removal of fine material from the product.

Obviously, many modifications may be made without departing from the basic spirit of the present invention. Accordingly, it will be appreciated by those skilled in the art that within the scope of the appended claims, the invention may be practiced other than has been specifically described herein.

What is claimed is:

1. An apparatus for heating moisture containing solid granular materials such as low-rank coal, comprising a tower means for passing the coal via gravity from the top of the tower, and baffle means within the tower for passing heated gas through the coal in the tower, thereby removing moisture from the coal.

2. The apparatus of claim 1, wherein the temperature of the heated gas, the size of the inlet and outlet openings in the tower, and the rate of flow of the coal downwardly in the tower are selected for optimum efficiency in treating the coal.

3. The apparatus of claim 2, wherein the temperature of the heated gas of the inlet opening is approximately 700° F.

4. The apparatus of claim 1, wherein the inlet velocity of the gas from the inlet opening is approximately 60 fps and the exit velocity of the gas from the outlet opening is approximately 40 fps.

5. The apparatus of claim 1, wherein the oxygen content of the heated gas is less than 5%.

6. The apparatus of claim 1, wherein the apparatus has no moving parts.

7. The apparatus of claim 1, wherein the baffle means communicate with a plenum, the plenum being sloped towards exits near the bottom of the tower wherein fine particles that disengage from the outlet gas rejoin the processed coal.

8. A thermal processor for coal to safely and efficiently reduce the moisture content of the coal comprising:
a processor having a plurality of baffles, the baffles being disposed transversely in the processor and spaced to accommodate coal flow, each baffle having a respective end having a cross-sectional area, the ends of the baffles communicating with an inlet plenum or an outlet plenum as required,
a source of inert gas heated to a preselected temperature, the gas being introduced into the inlet plenum wherein the gas is uniformly distributed throughout the coal volume, the gas flows into the processor, through the coal and exits to the outlet plenum,
an opening formed in the top of the processor,
untreated coal having a maximum selected size and screened to remove a portion of the fine particles being introduced continuously into the opening in the top of the processor, the coal passing through the processor by gravity, the coal being heated by the heated inert gas to remove moisture but not to remove VOCs.

9. The processor of claim 8, wherein the temperature of the heated gas at inlet plenum is approximately 700° F.

10. The processor of claim 8, wherein the coal does not exceed approximately 3 inches.

11. The processor of claim 10, wherein the coal does not exceed two inches.

12. The processor of claim 8, wherein the processor has no moving parts.
